(19) United States
(12) Patent Application Publication
(10) Pub. No.: US 2026/0140063 A1
(43) Pub. Date: May 21, 2026

(54) OPTICAL INSPECTION DEVICE

(71) Applicant: MLMTEK Co., Ltd., Taoyuan City (TW)

(72) Inventor: YU-CHIA CHANG, New Taipei City (TW)

(21) Appl. No.: 19/383,779

(22) Filed: Nov. 10, 2025

(30) Foreign Application Priority Data
Nov. 20, 2024 (TW) 113144605

(51) Int. Cl. G01N 21/88; G01N 21/84

(52) U.S. Cl. CPC G01N 21/8806; G01N 2021/8477; G01N 2021/8848; G01N 2201/0683

(57) ABSTRACT

An optical inspection device includes a light source module, a container structure, a first polarizer, a first electrode, a second polarizer, a second electrode and an image inspection module. The container structure can accommodate a liquid crystal material. The image inspection module is disposed adjacent to the container structure. The first polarizer and the first electrode are disposed between the light source module and the container structure. The second polarizer and the second electrode are disposed between the container structure and the image inspection module. Thereby, when the light-transmitting substrate is disposed within a liquid crystal material of the container structure, the light source module can generate light beams projected onto the light-transmitting substrate, and the image inspection module is configured to inspect the light beams that pass through the light-transmitting substrate or are reflected by the light-transmitting substrate.

### CROSS-REFERENCE TO RELATED PATENT APPLICATION

This application claims the benefit of priority to Taiwan Patent Application No. 113144605, filed on November 20, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical inspection device, and more particularly to an optical inspection device for inspecting a light-transmitting substrate.

### BACKGROUND OF THE DISCLOSURE

In the modern semiconductor industry, the printed circuit board (PCB) serves as a substrate for carrying various electronic components and conductive circuits, and is widely used in consumer electronics, medical devices, industrial equipment, lighting, automobiles, and the aerospace industry. Currently, the most commonly used materials for the PCB are fiberglass and resin. The glass material is widely used in electronic devices such as display panels due to its high flatness and excellent heat dissipation capability. Focusing on the PCB composed of glass material, the PCB typically incorporates a multitude of through-glass vias (TGVs). The TGVs can penetrate the internal structure of the glass substrate, and the TGVs can serve to connect the circuits on the two opposite surfaces of the glass PCB after filling with a conductive material.

However, it is impossible to inspect it by visual inspection alone due to the small size, high density and complex structure of the TGVs, so that the TGVs need to be inspected through the method of using the automated optical inspection (AOI). However, there are still the following technical problems when using the AOI:

(1) Insufficient optical contrast: the optical contrast between the TGVs and the surroundings is low due to the high transparency of the glass substrate, so that it is difficult for AOI to accurately and quickly identify defects such as hole wall defects, uneven hole diameters, and hole blockages;

(2) Surface optical interference: surface unevenness, scratches, and defects on the glass substrate introduce scattering and reflection, thereby reducing AOI accuracy; and

(3) Difficulty in real-time parameter adjustment: since different batches of the glass substrate and the processing process may vary, the AOI systems usually adjust detection parameters manually, resulting in low AOI detection efficiency unsuitable for rapidly changing production environments.

### SUMMARY OF THE DISCLOSURE

In response to the above-referenced technical inadequacy, the present disclosure provides an optical inspection device for improving the inspection contrast and inspection accuracy of a light-transmitting substrate.

In order to solve the above-mentioned problems, one of the technical aspects adopted by the present disclosure is to provide an optical inspection device, which includes a light source module, a container structure, a first polarizer, a first electrode, a second polarizer, a second electrode and an image inspection module. The light source module is configured to generate a plurality of light beams. The container structure is configured to accommodate a liquid crystal material and a light-transmitting substrate, the light-transmitting substrate includes a plurality of through holes, and the liquid crystal material and the light-transmitting substrate are located between a first side and a second side of the container structure. The first polarizer is configured to be disposed adjacent to the first side of the container structure. The first electrode is configured to be disposed adjacent to the first side of the container structure. The second polarizer is configured to be disposed adjacent to the second side of the container structure. The second electrode is disposed adjacent to the second side of the container structure. The image inspection module is configured to inspect the light beams that pass through the first polarizer, the first electrode, the container structure, the second polarizer, and the second electrode. The first electrode and the second electrode are configured to generate an electric field between the first electrode and the second electrode. When the liquid crystal material and the light-transmitting substrate are present in the container structure, the light-transmitting substrate is immersed in the liquid crystal material, the through holes are filled with the liquid crystal material, and the image inspection module is configured to inspect the light beams that pass through the liquid crystal material or the light-transmitting substrate.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an optical inspection device according to an embodiment of the present disclosure;

FIG. 2 is a schematic view of a light-transmitting substrate placed in a liquid crystal material according to an embodiment of the present disclosure;

FIG. 3 is a schematic enlarged view of portion III of FIG. 2;

FIG. 4 is a schematic cross-sectional view taken along line IV-IV of FIG. 3;

FIG. 5 is a schematic view of an inspection image captured by the image inspection module according to an embodiment of the present disclosure;

FIG. 6 is a schematic view showing the configuration relationship between a hole structure and a plurality of sub-electrodes of the optical inspection device according to an embodiment of the present disclosure; and

FIG. 7 is a schematic view of the optical inspection device according to another embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. It should be noted that the examples described below are merely one feasible embodiment and are not intended to limit the scope of the present disclosure.

### First Embodiment

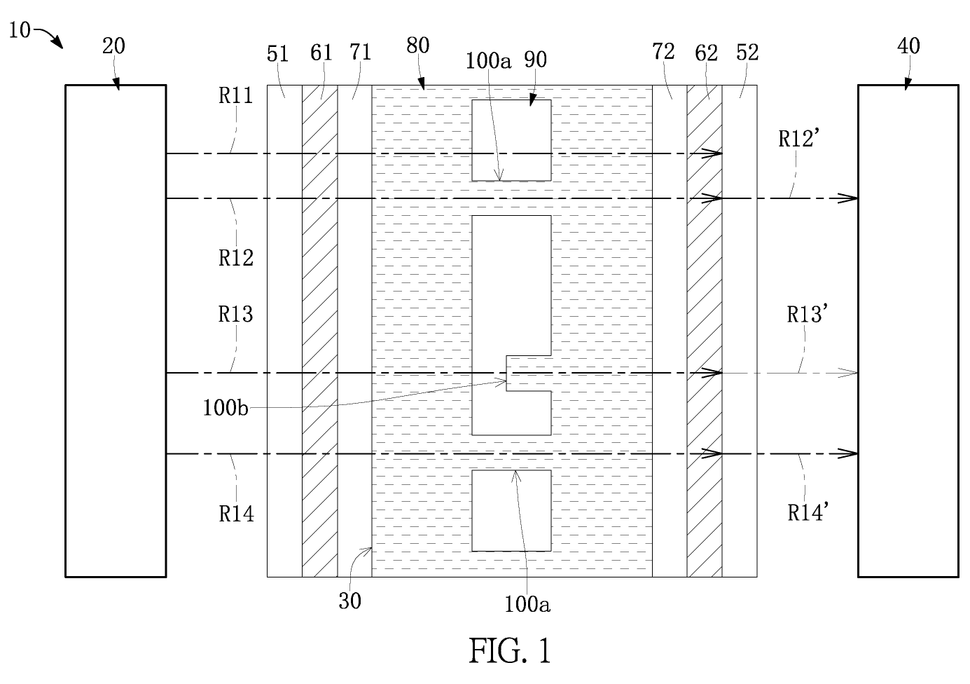

FIG. 1 is a schematic view of an optical inspection device according to an embodiment of the present disclosure. As shown in FIG. 1, the optical inspection device 10 (or optical detection device) can be configured to inspect (or detect, or observe) the hole morphology (or hole appearance) or the surface morphology (or surface appearance) of a substrate structure (such as a light-transmitting substrate). More particularly, the optical inspection device 10 may include at least one light source module 20 (or light-generating module), at least one container structure 30 (or reservoir structure), at least one image inspection module 40 (or image detection module), at least one first polarizer 51, at least one second polarizer 52, at least one first electrode 61, and at least one second electrode 62, and the optical inspection device 10 may further include a first alignment film 71 and a second alignment film 72.

More particularly, the light source module 20 can be configured to generate a plurality of light beams (R11, R12, R13, R14) that has substantially the same physical characteristics (such as peak wavelength and/or peak intensity). For example, the wavelength of each light beam may range from 300 nm to 900 nm (such as any positive integer between 300 nm and 900 nm), and the preferred wavelength range can be visible light from 400 nm to 750 nm. In addition, the light beam can be single-peak light or multi-peak light according to different requirements.

More particularly, as shown in FIG. 1, the container structure 30 can be configured to provide a storage space (or an accommodation space). Therefore, when the optical inspection device 10 is in operation, the container structure 30 can accommodate the liquid crystal material 80 and the light-transmitting substrate 90. For example, two polarizers (such as the first polarizer 51 and the second polarizer 52) and two electrodes (such as the first electrode 61 and the second electrode 62) can be disposed on two opposite sides (such as the first side and the second side) of the container structure 30. In addition, other material layers (for example, two alignment films such as the first alignment films 71 and second alignment films 72, two anti-reflection films such as a first anti-reflection film and a second anti-reflection films, two phase retarders such as a first phase retarder and a second phase retarder, or any optical layers) can be further disposed on two opposite sides of the container structure 30 according to different requirements.

For example, according to the embodiment shown in FIG. 1, the first side of the container structure 30 can be provided with the first polarizer 51, the first electrode 61 and the first alignment film 71, and the second side of the container structure 30 can be provided with the second polarizer 52, the second electrode 62 and the second alignment film 72. In addition, according to one embodiment, an optical path structure including a concave lens, a convex lens, a reflector, or a beam splitter can be used to configure the container structure 30 to have a fan-shaped or arc-shaped configuration. The first side and the second side of the container structure 30 can be respectively located at two end surfaces of the fan-shaped or arc-shaped configuration, and the first side and the second side of the container structure 30 can be parallel to the radius of the fan-shaped or arc-shaped configuration.

For example, according to the embodiment shown in FIG. 1, the transmission axes (such as light polarization directions or electric field directions) of the first polarizer 51 and the second polarizer 52 can be perpendicular to each other. Therefore, when the light beams provided by the light source module 20 pass through the first polarizer 51 and the polarization direction is not further reoriented or turned, the light beams (or reflected light beams) cannot directly pass through the second polarizer 52.

For example, according to the embodiment shown in FIG. 1, the first electrode 61 and the second electrode 62 can be transparent conductive electrodes, allowing the light beams provided by the light source module 20 to pass through the first electrode 61 and the second electrode 62. In addition, the first electrode 61 and the second electrode 62 can be electrically connected to an appropriate voltage (power source) to generate a bias voltage between the first electrode 61 and the second electrode 62. The present disclosure can change the direction of the directors of the liquid crystal molecules in the liquid crystal material 80 by applying an appropriate bias voltage, thereby changing the polarization direction of the light beams passing through the liquid crystal material 80.

For example, according to the embodiment shown in FIG. 1, the first alignment film 71 and the second alignment film 72 can be adjacent to the container structure 30 and directly contact the liquid crystal material 80, thereby creating a pre-tilt angle for the liquid crystal molecules to control the orientation of the liquid crystal molecules through an applied electric field.

For example, according to the embodiment shown in FIG. 1, the image inspection module 40 can be configured to inspect or detect the light beams passing through the first polarizer 51, the first electrode 61, the container structure 30, the second polarizer 52, and the second electrode 62. Therefore, when the container structure 30 contains a liquid crystal material 80 and at least one light-transmitting substrate 90, the image inspection module 40 can be configured to inspect or detect the light beams (R12’, R13’, R14’) passing through the liquid crystal material 80 or the light-transmitting substrate 90, thereby obtaining a partial image or a full image of the object (such as the light-transmitting substrate 90). In addition, the image inspection module 40 may include a complementary metal oxide semiconductor (CMOS) image sensor or a charge coupled device (CCD) image sensor.

For example, according to the embodiment shown in FIG. 1, the liquid crystal material 80 can be a nematic liquid crystal, a smectic liquid crystal, or a cholesteric liquid crystal according to different requirements. Furthermore, the light-transmitting substrate 90 (such as a glass substrate) can be made of a transparent material that allows light with a wavelength of at least 350 nm to pass through. In other words, the ratio of the intensity of the penetrating light (or transmitted light) passing through the light-transmitting substrate 90 to the intensity of the input light (or incident light) entering the light-transmitting substrate 90 is greater than 75%, or 95%. Moreover, the light-transmitting substrate 90 may include a plurality of through holes 100a or a plurality of blind holes 100b, and the inner walls (light-reflecting surfaces) of the through holes 100a and the blind holes 100b can be a part of the light-transmitting substrate 90. In addition, the light-transmitting substrate 90 can be immersed in the liquid crystal material 80, so that the liquid crystal material 80 can fill the through holes 100a and the blind holes 100b, and the liquid crystal material 80 can directly contact the inner walls of the through holes 100a and the blind holes 100b.

For example, according to the embodiment shown in FIG. 1, when the optical inspection device 10 is in operation, the light beams (R11, R12, R13, R14) provided by the light source module 20 can enter the liquid crystal material 80 and pass through the light-transmitting substrate 90. Simultaneously, a bias voltage is generated between the first electrode 61 and the second electrode 62, thereby changing the optical activity of the liquid crystal material 80 (i.e., changing the polarization direction of the liquid crystal molecules used to rotate light in certain directions). Moreover, the light-transmitting substrate 90 may include a plurality of through holes 100a or a plurality of blind holes 100b, so that when the light beams (R11, R12, R13, R14) pass through the liquid crystal material 80, the path lengths of the light beams (R11, R12, R13, R14) in the liquid crystal material 80 can be different, resulting in varying degrees of change in the polarization of the light beams (R11, R12, R13, R14). In other words, when the light beams (R11, R12, R13, R14) pass through the liquid crystal material 80, a portion of the light beams may pass through the second polarizer 52, another portion of the light beams may not pass through the second polarizer 52, and yet another portion of the light beams (with relatively low light intensity) may pass through the second polarizer 52.

For example, in the embodiment shown in FIG. 1, the light beam R11 does not pass through the through hole 100a and the blind hole 100b, so that the path length of the light beam R11 within the liquid crystal material 80 (or the optical path of the light beam R11 passing through the liquid crystal material 80) can be minimized, preventing the light beam R11 from passing through the second polarizer 52. Moreover, the light beams (R12, R14) can pass through the liquid crystal material 80 within the through hole 100a, so that the path length of the light beams (R12, R14) within the liquid crystal material 80 (or the optical path of the light beams (R12, R14) passing through the liquid crystal material 80) can be maximized, allowing the light beams (R12, R14) to pass through the second polarizer 52. In addition, the light beam R13 can pass through the liquid crystal material 80 within the blind hole 100b, so that the path length of the light beam R13 within the liquid crystal material 80 (or the optical path of the light beam R13 passing through the liquid crystal material 80) can be centered, allowing the light beam R13 to partially pass through the second polarizer 52.

For example, according to the embodiment shown in FIG. 1, the refractive index of the liquid crystal material 80 (n=1.2~2.5) can be greater than the refractive index of the light-transmitting substrate 90 (n=1.3~1.7), so that when the light beams pass through the through holes 100a or the blind holes 100b, the light beams can be totally reflected by the inner walls of the through holes 100a or the blind holes 100b, thereby facilitating the observation of the morphology of the inner walls of the through holes 100a or the blind holes 100b.

Therefore, according to the embodiment shown in FIG. 1, by using the light beams provided by the optical inspection device 10, the reflected light beams (R12’, R13’, R14’) with different intensities can be correspondingly formed in different areas of the light-transmitting substrate 90, thereby enabling inspecting or detecting by the image inspection module 40 to obtain partial or full images of the light-transmitting substrate 90. In other words, the optical contrast (or image contrast) of the partial or full images obtained from the different areas (different target areas) of the light-transmitting substrate 90 can be improved, particularly the optical contrast between each hole (such as the through hole 100a or the blind hole 100b) and its edge of the adjacent light-transmitting substrate 90, the present disclosure can be used to address the technical problem in being unable to accurately and efficiently detect holes and their edges of the substrate.

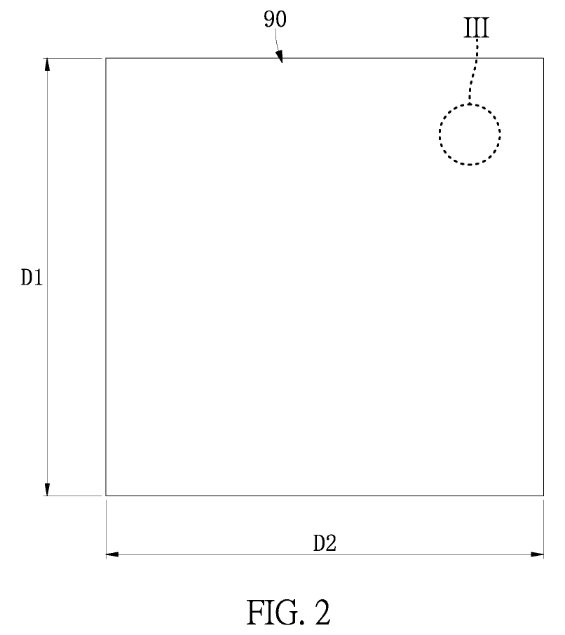

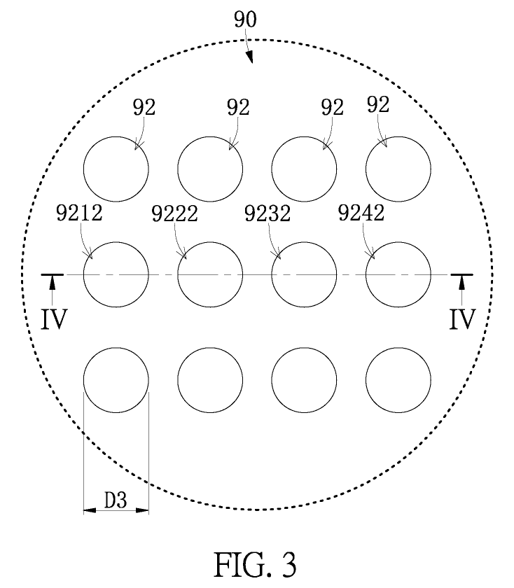

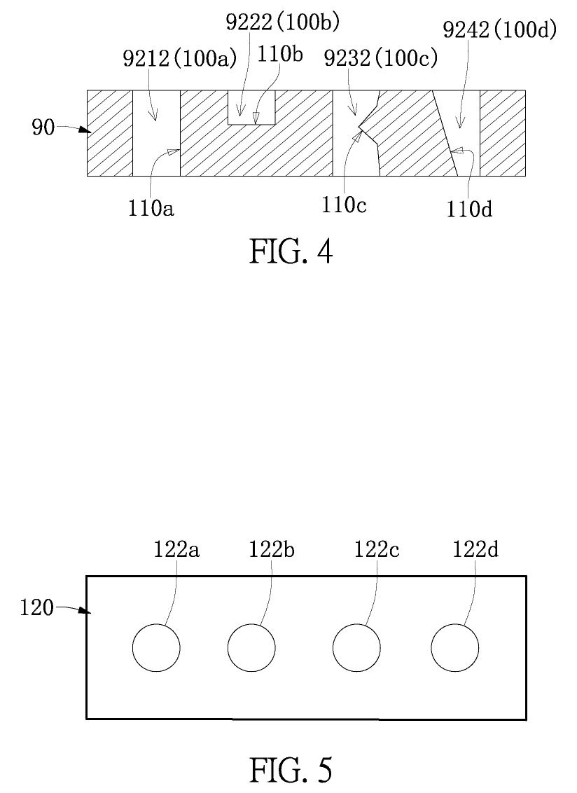

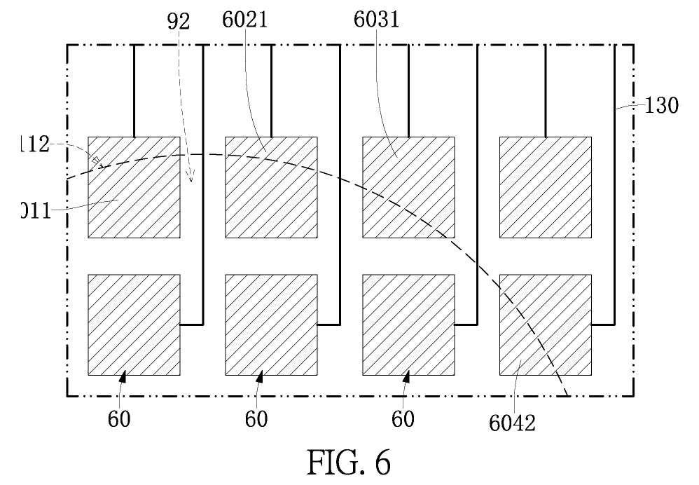

More specifically, FIG. 2 is a schematic view of a light-transmitting substrate placed in a liquid crystal material according to an embodiment of the present disclosure; FIG. 3 is a schematic enlarged view of portion III of FIG. 2; FIG. 4 is a schematic cross-sectional view taken along line IV-IV of FIG. 3; FIG. 5 is a schematic view of an inspection image captured by the image inspection module according to an embodiment of the present disclosure; and FIG. 6 is a schematic view showing the configuration relationship between a hole structure and a plurality of sub-electrodes of the optical inspection device according to an embodiment of the present disclosure.

For example, as shown in FIG. 2, according to one feasible embodiment of the present disclosure, the light-transmitting substrate 90 may be a rectangular glass circuit board. One side of the light-transmitting substrate 90 has a first length D1, and another side of the light-transmitting substrate 90 has a second length D2. The first length D1 and the second length D2 may be between 5 cm and 100 cm (e.g., any positive integer between 5 cm and 100 cm). Depending on different embodiments, the appearance and dimensions of the light-transmitting substrate 90 can be adjusted according to different requirements.

For example, as shown in FIG. 2 and FIG. 3, according to one feasible embodiment of the present disclosure, the light-transmitting substrate 90 may include a plurality of hole structures 92. The hole structures 92 may include a plurality of through holes 100a or blind holes 100b as shown in FIG. 1, or any recessed structures. From the top view of FIG. 3, the maximum aperture length (e.g., diameter D3) of each hole structure 92 can be between 0.002 mm and 3 mm (e.g., any positive integer between 2 μm and 3000 μm), and the inner wall of each hole structure 92 is not covered by any metal layer.

For example, as shown in FIG. 3 and FIG. 4, according to one feasible embodiment of the present disclosure, the hole structures (9212, 9222, 9232, 9242) of the light-transmitting substrate 90 can correspond to the through hole 100a, the blind hole 100b, and the abnormal morphological holes (100c, 100d), respectively. Moreover, the hole structures (9212, 9222, 9232, 9242) may each include inner walls (110a, 110b, 110c, 110d), in which the inner wall 110a may include at least one vertical sidewall, the inner wall 110b may include at least one horizontal bottom surface, the inner wall 110c may include at least one lateral protrusion, and the inner wall 110d may include at least one inclined sidewall. It should be noted that the morphology and appearance of each inner wall (110a, 110b, 110c, 110d) are merely illustrative. The actual morphology and appearance may be varied and adjusted based on actual processing conditions and methods, or different requirements, and the roughness of each inner wall (110a, 110b, 110c, 110d) may also be varied and adjusted based on actual processing conditions and methods, or different requirements.

For example, as shown in FIG. 4 and FIG. 5, according to one feasible embodiment of the present disclosure, the inspection image 120 obtained by the image inspection module 40 may include a plurality of characteristic images (122a, 122b, 122c, 122d), and the characteristic images (122a, 122b, 122c, 122d) may correspond to the through hole 100a, the blind hole 100b, and the abnormal morphological holes (100c, 100d), respectively. In other words, the present disclosure can use the image inspection module 40 to inspect or detect the through hole 100a, the blind hole 100b, and the abnormal morphological holes (100c, 100d), thereby obtaining an inspection image 120 having a plurality of characteristic images (122a, 122b, 122c, 122d). It should be noted that the brightness distribution of each characteristic image 122 can show its uniqueness. For example, the brightness distribution of the characteristic image 122a can be uniform overall; the brightness distribution of the characteristic image 122b can be uniform overall, but its overall brightness is different from that of the characteristic image 122a; the brightness distribution of the characteristic image 122c can be locally uneven (affected by the lateral protrusion of the inner wall 110c); and the brightness distribution of the characteristic image 122d can be locally gradient (affected by the inclined sidewall). Moreover, each characteristic image (122a, 122b, 122c, 122d) can be a three-dimensional stereo image (or spectral signal), thereby presenting the surface morphology of the inner wall of each hole structure 82 in a three-dimensional manner (or spectral analysis).

For example, as shown in FIG. 1 and FIG. 4, according to one feasible embodiment of the present disclosure, by using the optical inspection device 10 shown in FIG. 1, the electric field generated between the first electrode 61 and the second electrode 62 can be adjusted to change the polarization direction of the light beams corresponding to different regions of the light-transmitting substrate 90, thereby affecting the degree of the light beams passing through the second polarizer 52. As a result, the optical inspection device 10 can be configured to inspect or detect with high precision and efficiency to obtain the inspection images 120 of the through holes 100a, the blind holes 100b, and the abnormal morphological hole (100c, 100d).

For example, as shown in FIG. 1, FIG. 3 and FIG. 6, according to one feasible embodiment of the present disclosure, at least one of the first electrode 61 and the second electrode 62 may include a plurality of sub-electrodes 60, and each of the sub-electrodes 60 can be electrically connected to a plurality of conductive lines 130. From the top view of FIG. 6, the projected area (vertical projection area) of each sub-electrode 60 can be smaller than the projected area (vertical projection area) of each hole structure 92 (such as the through hole 100a, the blind hole 100b, and the abnormal morphological holes 100c and 100d). Furthermore, a part of the sub-electrodes (such as sub-electrodes 6011, 6021, 6031, 6042) can overlap with the opening edge 112 (or opening boundary, or opening outline) of the hole structure 92. Alternatively, depending on the requirements of different embodiments, the vertical projection of the hole structure 92 can fall on the corresponding sub-electrodes 60.

For example, as shown in FIG. 4, FIG. 5, and FIG. 6, according to one feasible embodiment of the present disclosure, different voltages can be applied to the multiple sub-electrodes 60, so that the brightness of the characteristic image 122 presented by the hole structure 92 or its inner wall in the corresponding area can be adjusted, thereby obtaining the inspection image 120 of the through hole 100a, the blind hole 100b and the abnormal morphological hole (100c, 100d) with high precision and high efficiency.

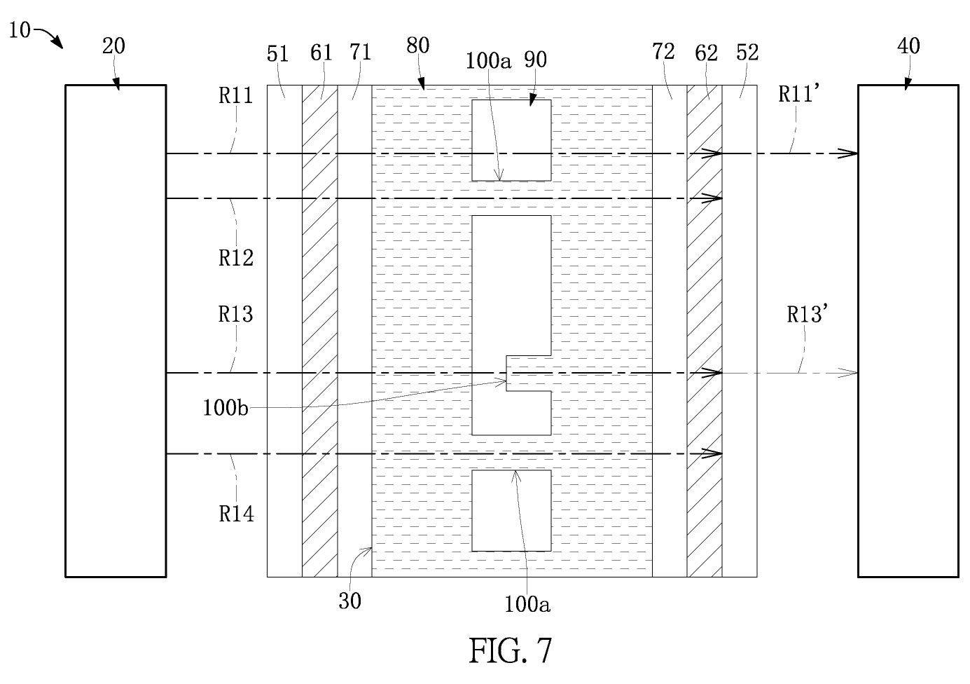

More particularly, FIG. 7 is a schematic view of the optical inspection device according to another embodiment of the present disclosure. As shown in FIG. 7, the optical inspection device 10 provided in FIG. 7 is similar to the optical inspection device 10 provided in FIG. 1. The main difference between the embodiment shown in FIG. 7 and the embodiment shown in FIG. 1 is that the image inspection module 40 of the optical inspection device 10 can modify or adjust the lateral size of the container structure 30, the angle difference between the transmission axes of the first polarizer 51 and the second polarizer 52 (such as the relative optical configuration relationship between the first polarizer 51 and the second polarizer 52), the concentration or type of the liquid crystal material 80, or any configurations to ensure that the image presented by the through hole 100a of the light-transmitting substrate 90 is dark rather than bright (that is to say, the light beams R12 and R14 cannot pass through the second polarizer 52, so that the characteristic image of the through hole 100a cannot be detected by the image inspection module 40), and the image presented by the main body of the light-transmitting substrate 90 is bright rather than dark (that is to say, the light beams R11 and R13 can pass through the second polarizer 52 smoothly, allowing the characteristic image in areas other than the through hole 100a to be detected by the image inspection module 40).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical inspection device, comprising:
a light source module configured to generate a plurality of light beams;
a container structure configured to accommodate a liquid crystal material and a light-transmitting substrate, wherein the light-transmitting substrate includes a plurality of through holes, and the liquid crystal material and the light-transmitting substrate are located between a first side and a second side of the container structure;
a first polarizer configured to be disposed adjacent to the first side of the container structure;
a first electrode configured to be disposed adjacent to the first side of the container structure;
a second polarizer configured to be disposed adjacent to the second side of the container structure;
a second electrode disposed adjacent to the second side of the container structure; and
an image inspection module configured to inspect the light beams that pass through the first polarizer, the first electrode, the container structure, the second polarizer, and the second electrode;
wherein the first electrode and the second electrode are configured to generate an electric field between the first electrode and the second electrode; and
wherein, when the liquid crystal material and the light-transmitting substrate are present in the container structure, the light-transmitting substrate is immersed in the liquid crystal material, the through holes are filled with the liquid crystal material, and the image inspection module is configured to inspect the light beams that pass through the liquid crystal material or the light-transmitting substrate.

2. The optical inspection device according to claim 1, further comprising: at least one alignment film being disposed adjacent to the container structure and configured to directly contact the liquid crystal material.

3. The optical inspection device according to claim 1,
wherein at least one of the first electrode and the second electrode includes a plurality of sub-electrodes, each of the sub-electrodes is electrically connected to a plurality of conductive lines, and a vertical projection area of each of the sub-electrodes is smaller than a vertical projection area of each of the through holes; and
wherein a vertical projection of a part of the sub-electrodes falls on an opening edge of a corresponding one of the through holes.

4. The optical inspection device according to claim 1,
wherein each of the through holes has a diameter between 0.002 mm and 3 mm; and
wherein an inner wall of each of the through holes is a portion of the light-transmitting substrate.

5. The optical inspection device according to claim 1, wherein a refractive index of the liquid crystal material is greater than a refractive index of the light-transmitting substrate.

6. The optical inspection device according to claim 1, wherein, when the liquid crystal material and the light-transmitting substrate are present in the container structure, the liquid crystal material directly contacts an inner wall of each of the through holes.

7. The optical inspection device according to claim 1, wherein, when the liquid crystal material and the light-transmitting substrate are present in the container structure, a part of the light beams provided by the light source module passes through the light-transmitting substrate, and another part of the light beams provided by the light source module passes through the liquid crystal material located in the through holes.

8. The optical inspection device according to claim 1, wherein the light-transmitting substrate further includes a plurality of blind holes; and wherein, when the liquid crystal material and the light-transmitting substrate are present in the container structure, the blind holes are filled with the liquid crystal material.

9. An optical inspection device, comprising:
a light source module configured to generate a plurality of light beams;
a container structure configured to accommodate a liquid crystal material and a light-transmitting substrate;
a first polarizer configured to be adjacent to the container structure;
a first electrode configured to be adjacent to the container structure;
a second polarizer configured to be adjacent to the container structure;
a second electrode configured to be adjacent to the container structure; and
an image inspection module configured to inspect the light beams that pass through the first polarizer, the first electrode, the container structure, the second polarizer, and the second electrode;
wherein the first polarizer and the first electrode are disposed on a same side of the container structure, and the second polarizer and the second electrode are disposed on another side of the container structure; and
wherein the image inspection module is configured to inspect the light beams that pass through the light-transmitting substrate.

10. An optical inspection device, comprising:
a light source module;
a container structure configured to contain a liquid crystal material;
an image inspection module disposed adjacent to the container structure;
a first polarizer disposed between the light source module and the container structure;
a first electrode disposed between the light source module and the container structure;
a second polarizer disposed between the container structure and the image inspection module; and
a second electrode disposed between the container structure and the image inspection module;
wherein, when a light-transmitting substrate is disposed within the liquid crystal material in the container structure, the light source module is configured to generate a plurality of light beams projected onto the light-transmitting substrate; and
wherein the image inspection module is configured to inspect the light beams that pass through or are reflected by the light-transmitting substrate.
